(19) United States
(12) Patent Application Publication
(10) Pub. No.: US 2015/0356304 A1
(43) Pub. Date: Dec. 10, 2015

(54) DEVICE AND METHOD FOR ACTIVATING SECURITY FUNCTION FOR CHATTING REGION

(71) Applicant: DAUM KAKO CORP., Jeju-do (KR)

(72) Inventor: In Young YOU, Seongnam-si (KR)

(21) Appl. No.: 14/764,689

(22) PCT Filed: Jan. 16, 2014
(86) PCT No.: PCT/KR2014/000472

§ 371 Date: Jul. 30, 2015

(30) Foreign Application Priority Data
Jan. 31, 2013 (KR) 10-2013-0011343

(51) Int. Cl. G06F 21/60; G06F 3/0484

(52) U.S. Cl. CPC G06F 21/60; G06F 3/04842

(57) ABSTRACT

There may be provided a method that activates a security function. The method includes: displaying a chatting region on a display of a user device; presenting chatting texts of multiple users on the displayed chatting region; receiving a security request signal for requesting activation of a security function through a user interface; receiving a signal for selecting a non-security region in the displayed chatting region through the user interface; and displaying the non-security region differently from a security region in the displayed chatting region.

### TECHNICAL FIELD

The embodiments described herein pertain generally to a device and method for activating a security function for a chatting region.

### BACKGROUND

IMS (Instant Message Service) refers to a real-time online communication service that enables a message transmitted from a sender to instantly appear on the screen of a device of a receiver without using an e-mail program or a web browser. In particular, a service for providing chatting and voice and video calls through a mobile network is referred to as MIM (Mobile Instant Messenger) service.

With the development of smart devices, it is possible for a user to use a smart device in various places without being limited to a location of the user. The user can be provided by the smart device with various contents such as web surfing, video viewing, and the like. Further, the user can be provided with MIM (Mobile Instant Messenger) service, SNS (Social Network Service), and the like through applications of the smart device operating on various platforms and can also communicate with other people through various channels.

When using a smart device for fun, the user may often feel other people's glance. When texts representing a private conversation or a personal feeling are exposed to other people, the user of the smart device may feel that his/her privacy is being exposed. Therefore, the user needs to pay attention to security in order for the texts representing a private conversation or a personal feeling not to be exposed to other people.

### DISCLOSURE OF THE INVENTION

### Problems to be Solved by the Invention

There is provided a device and method for activating a security function capable of hiding the contents of conversation during a messenger conversation in a public place by using the security function in a chatting region where texts are presented. There is also provided a device and method for activating a security function capable of improving user's convenience for security in a chatting region by dividing the chatting region on a display into a non-security region where the user wants to present texts and a security region where the user wants to hide texts. However, problems to be solved by the present exemplary embodiment are not limited to the above-described problems, and there may be other problems to be solved.

### Means for Solving the Problems

In one exemplary embodiment, there may be provided a method that activates a security function. The method includes: displaying a chatting region on a display of a user device; presenting chatting texts of multiple users on the displayed chatting region; receiving a security request signal for requesting activation of a security function through a user interface; receiving a signal for selecting a non-security region in the displayed chatting region through the user interface; and displaying the non-security region differently from a security region in the displayed chatting region.

In another exemplary embodiment, there may be provided a device. The device includes: a display configured to display a chatting region and present chatting texts of multiple users on the displayed chatting region; a signal input receiver configured to receive a security request signal for requesting activation of a security function through a user interface and receive a signal for selecting a non-security region in the displayed chatting region through the user interface; and a security function controller configured to display the non-security region differently from a security region in the displayed chatting region.

### Effects of the Invention

It is possible to provide a device and method for activating a security function capable of hiding the contents of conversation during a messenger conversation in a public place by using the security function in a chatting region where texts are presented. Further, it is also possible to provide a device and method for activating a security function capable of improving user's convenience for security in a chatting region by dividing the chatting region on a display into a non-security region where the user wants to present texts and a security region where the user wants to hide texts.

### BRIEF DESCRIPTION OF THE DRAWINGS

FIG. 1 is a configuration view of a security function providing system according to an exemplary embodiment of the present disclosure;

FIG. 2 is a configuration view of a device 20 according to an exemplary embodiment of the present disclosure;

FIG. 3A and FIG. 3B are diagrams provided to explain an example of a process for activating a security function;

FIG. 4A is a diagram showing an example in which a non-security region is shifted in position;

FIG. 4B is a diagram showing an example in which a non-security region is changed in size;

FIG. 5A and FIG. 5B are diagrams showing a process for activating a security function according to another exemplary embodiment of the present disclosure;

FIG. 6 is a diagram showing an example of a security icon; and

FIG. 7 is a flowchart of a method for activating a security function according to an exemplary embodiment of the present disclosure.

### MODE FOR CARRYING OUT THE INVENTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

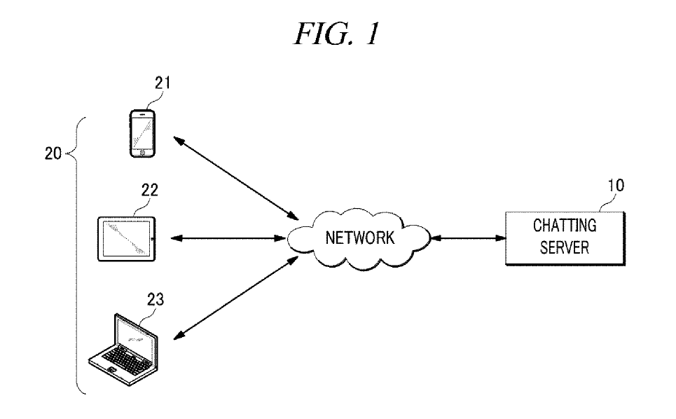

FIG. 1 is a configuration view of a security function providing system according to an exemplary embodiment of the present disclosure. Referring to FIG. 1, the security function providing system includes a chatting server 10 and a device 20. However, the security function providing system illustrated in FIG. 1 is just an exemplary embodiment of the present disclosure, and, thus, the present disclosure should not be limitedly construed by FIG. 1. That is, according to various exemplary embodiments of the present disclosure, the security function providing system may have a different configuration from that illustrated in FIG. 1.

The components of the security function providing system illustrated in FIG. 1 are typically connected to each other through a network. The network refers to a connection structure that enables information exchange between nodes such as devices and servers. Examples of the network may include 3GPP (3rd Generation Partnership Project) network, LTE (Long Term Evolution) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, satellite broadcasting network, analog broadcasting network, DMB (Digital Multimedia Broadcasting) network, and the like, but may not be limited thereto.

Referring to FIG. 1, a first network that connects the chatting server 10 with the multiple devices 20 and a second network that connects a device 22 with a device 23 may be of different types. By way of example, the first network may be a broadband network and the second network may be a local area network. Herein, an example of the broadband network may be a LTE network and an example of the local area network may be a Wireless LAN.

According to an exemplary embodiment of the present disclosure, the chatting server 10 may receive chatting data from any one of the multiple devices 20 and transmit the received chatting data to another one of the multiple devices 20. Herein, the chatting server 10 may receive the chatting data and transmit the received chatting data through the first network. The chatting data may include at least any one of a text or image data.

According to yet another exemplary embodiment of the present disclosure, chatting data may be directly transmitted from the device 22 to the device 23. That is, chatting data may be directly transmitted between the device 22 and the device 23 through the second network that connects the device 22 with the device 23 without passing through the chatting server 10.

The device 20 presents the chatting data received from the chatting server 20 on a display. In this case, the chatting data may be chatting data written by another device. Further, the device 20 transmits chatting data input through a user interface to the chatting server 10. In this case, the chatting server 10 may transmit the received chatting data to another device. Generally, chatting data may include texts, image and sound data, and the like, but may not be limited thereto.

The device 20 activates a security function when a security request signal is input through the user interface. If the security function is activated, a security region in the chatting region is displayed differently from a non-security region. Generally, a security region means a region where chatting data are hidden, and a non-security region means a region where chatting data are presented. Readability of chatting data is significantly low in the security region as compared with the non-security region, and, thus, another user cannot recognize chatting data presented within the security region.

The device 20 can activate a region corresponding to a certain position selected through the user interface as a non-security region. As such, each device 20 activates a region that is selected by the user as a non-security region and a region that is not selected by the user as a security region, which enables security for the user's chatting data. According to an example of activation of a security region, an opaque image for hiding a security region may be overlapped with the security region and a transparent image for presenting a non-security region may be overlapped with the non-security region, but the present disclosure may not be limited thereto. By way of example, according to another example of activation of a security region, an image having transparency of 20% for reducing readability of a security region may be overlapped with the security region and an image having image having transparency of 90% may be overlapped with a non-security region. According to yet another example of activation of a security region, a security region may be dimly displayed and a non-security region may be brightly displayed.

According to various exemplary embodiments of the present disclosure, the device 20 may be of various forms. By way of example, the device may be a TV apparatus, a computer, or a portable device which can be connected to a remote server through a network. Herein, examples of the TV apparatus may include a smart TV and an IPTV set-top box, examples of the computer may include a notebook, a desktop, and a laptop equipped with a WEB browser, and examples of the portable device may include a portable wireless communication device that ensures portability and mobility and includes any kind of handheld-based wireless communication device such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminal, smart phone, tablet PC, or the like.

Hereinafter, operations of the respective components included in the security function providing system illustrated in FIG. 1 will be described in more detail.

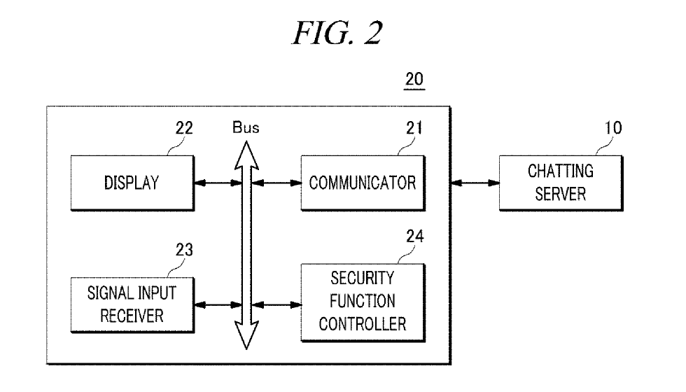

FIG. 2 is a configuration view of the device 20 according to an exemplary embodiment of the present disclosure. The device 20 may refer to any one of the devices 20 illustrated in FIG. 1, but may not be limited to the devices 20 illustrated in FIG. 1.

Referring to FIG. 2, the device 20 includes a communication part 21, a display part 22, a signal input part 23, and a security function control part 24. However, the device 20 illustrated in FIG. 2 is one exemplary embodiment of the present disclosure and can be modified or changed in various ways on the basis of the components illustrated in FIG. 2. By way of example, the device 20 may further include an audio output device that outputs audio and a display that outputs images.

The communicator 21 receives chatting data of an external device (not illustrated) through a network. Herein, the communicator 21 may receive chatting data from the chatting server 10. Generally, the chatting data may include at least any one of texts, image data, and sound data, but may not be limited thereto.

Further, the communicator 21 may transmit chatting data to the external device (not illustrated) connected through the network. Generally, the external device (not illustrated) may be any one of the devices 20 illustrated in FIG. 1, but may not be limited to the devices 20 illustrated in FIG. 1.

The communicator 21 may receive information (for example, identification information or selection information) related to chatting data from the chatting server 10 and receive chatting data from the chatting server 10 through the received information. That is, the chatting server 10 transmits only identification information related to chatting data to the devices while storing the chatting data therein, and if a certain device requests chatting data through identification information, the chatting server 10 may transmit the requested chatting data to the device.

According to another exemplary embodiment of the present disclosure, the communicator 21 may directly transmit chatting data to the external device (not illustrated) without passing through the chatting server 10.

The display 22 present chatting data in a chatting region. Herein, the chatting data may be chatting data received from the external device (not illustrated) or chatting data input through the user interface. Generally, the chatting region is a graphic region configured to present chatting data and displayed on the display when a chatting application is activated.

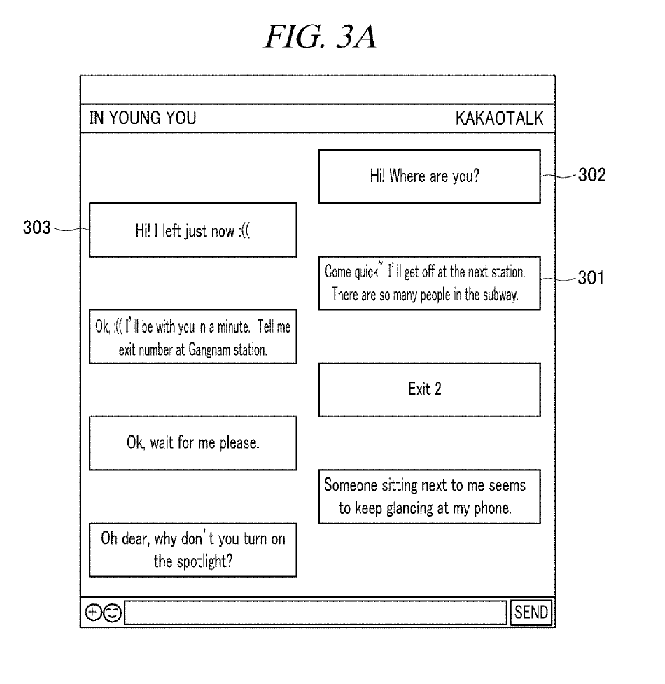

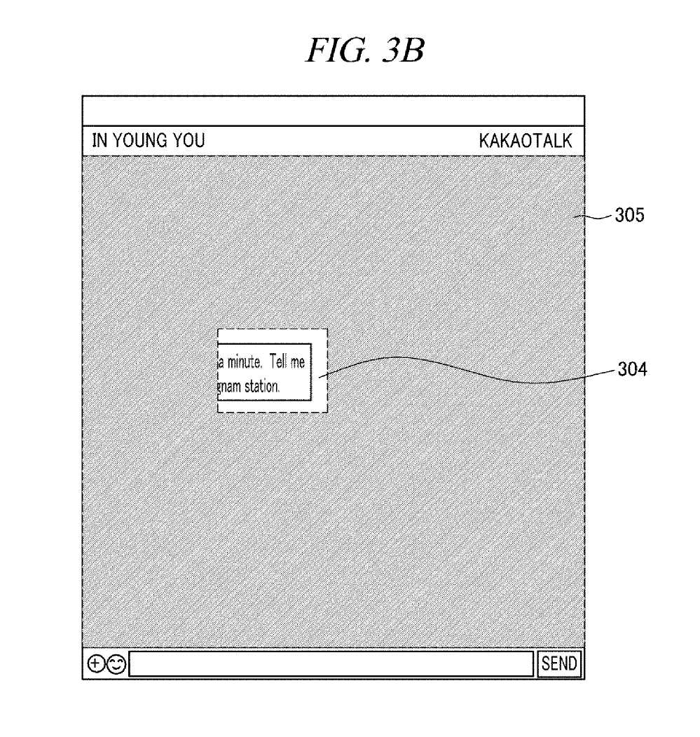

FIG. 3A and FIG. 3B are diagrams provided to explain an example of a process for activating a security function. The display 22 displays chatting data of multiple users in the chatting region. To be specific, the display 22 may display the user's chatting data input through the user interface in the chatting region or chatting data written by another user of an external device in the chatting region.

As exemplified in FIG. 3A, the display 22 may present a text “Hi! Where are you?” 302 input through the user interface or a text “Hi! I left just now :((?” 303 written by the external device (not illustrated), in a chatting region 301 displayed on the display of the device 20. Herein, the texts “Hi! Where are you?” 302 and “Hi! I left just now :((?” 303 may be respectively presented in text bubbles as illustrated in FIG. 3A.

The signal input receiver 23 receives a security request signal for requesting activation of a security function through the user interface. For example, if a chatting region or a security icon presented around the chatting region is selected through the user interface, the signal input receiver 23 may receive the selection of the security icon as a security request signal. For another example, if any one of the presented chatting data is selected through the user interface, the signal input receiver 23 may receive the selection of the chatting data as a security request signal.

The signal input receiver 23 receives a selection signal for a non-security region in the chatting region displayed through the user interface. For example, if a selection signal (for example, a click or touch signal) for a line or plane region in the chatting region is input through a touch interface, the signal input receiver 23 may recognize a square or circular region of a certain size surrounding the line or plane region as a non-security region. For another example, if a signal for drawing a boundary of a square or circular region in the chatting region is input through a touch interface, the signal input receiver 23 may recognize the drawn square or circular region as a non-security region.

The security function controller 24 displays a non-security region differently from a security region in the displayed chatting region. In this case, the security function controller 24 may generate a control signal for displaying the non-security region differently from the security region in the displayed chatting region, and the display 22 may display the non-security region differently from the security region in response to the generated control signal.

The display 22 may display the non-security region differently from the security region in the displayed chatting region on the basis of any one of multiple methods. In this case, according to a first method of the multiple methods, an opaque image of the same size and shape as the security region may be presented on the display, so that the non-security region may be displayed differently from the security region. Further, according to a second method of the multiple methods, the security region, which is the rest of the displayed chatting region except the non-security region, may be dimly displayed, so that the non-security region may be displayed differently from the security region. In this case, the security function controller 24 may generate a control signal for displaying the non-security region differently from the security region in the displayed chatting region on the basis of the first method or the second method, and the display 22 may display the non-security region differently from the security region in response to the generated control signal.

FIG. 3B illustrates an example of each of a security region 305 and a non-security region 304 in a chatting region. As exemplified in FIG. 3B, when a security function is activated, the display 22 may display the non-security region 304 differently from the security region 305 in the chatting region displayed on the display in response to a control signal input from the security function controller 24. In order to do so, the display 22 may display the non-security region differently from the security region by presenting an opaque image of the same size and shape as the security region on the display. Herein, the opaque image may be an additional layer image to be overlaid on the chatting region.

The display 22 may display the non-security region as a transparent image and the security region as an opaque image. Further, if a security request signal is input through the user interface, the display 22 may dimly display the security region, which is the rest of the displayed chatting region except the non-security region, so that the non-security region may be displayed differently from the security region. Furthermore, the display 22 may set the transparency of the security region differently from that of the non-security region, so that the non-security region may be displayed differently from the security region. The non-security region may be displayed in a bright color and the security region may be displayed in a dark color.

If a request for the non-security region is input through the user interface, the display 22 may graphically modify at least one of the security region and the non-security region on the basis of the input request. Herein, the request may be a certain modification request for the non-security region, and the display 22 may graphically modify at least one of the security region and the non-security region to apply a graphic effect, such as an animation effect, to the non-security region on the basis of the input modification request.

If a request for shifting the non-security region is input through the user interface, the display 22 may graphically modify at least one of the security region and the non-security region to shift the non-security region from a first position to a second position. Further, if a request for changing a size of the non-security region is input through the user interface, the display 22 may graphically modify at least one of the security region and the non-security region to change a size the non-security region from a first size to a second size. Furthermore, if a request for randomly shifting the non-security region is input through the user interface, the display 22 may graphically modify at least one of the security region and the non-security region to randomly shift the non-security region between at least two positions. Besides, on the basis of each request for the non-security region input through the user interface, the display 22 may graphically modify at least one of the security region and the non-security region to change a size of the non-security region from a square shape to another shape such as a circular shape or a hexagonal shape, apply a flicker effect to the non-security region, or additionally present a graphic image a sticker-type image on the non-security region.

If the request for shifting the non-security region is input through the user interface, the display 22 may shift the non-security region from the first position to the second position. In this case, the security function controller 24 may generate a control signal for shifting the non-security region from the first position to the second position in response to the shift request input through the user interface and transfer the generated control signal to the display 22.

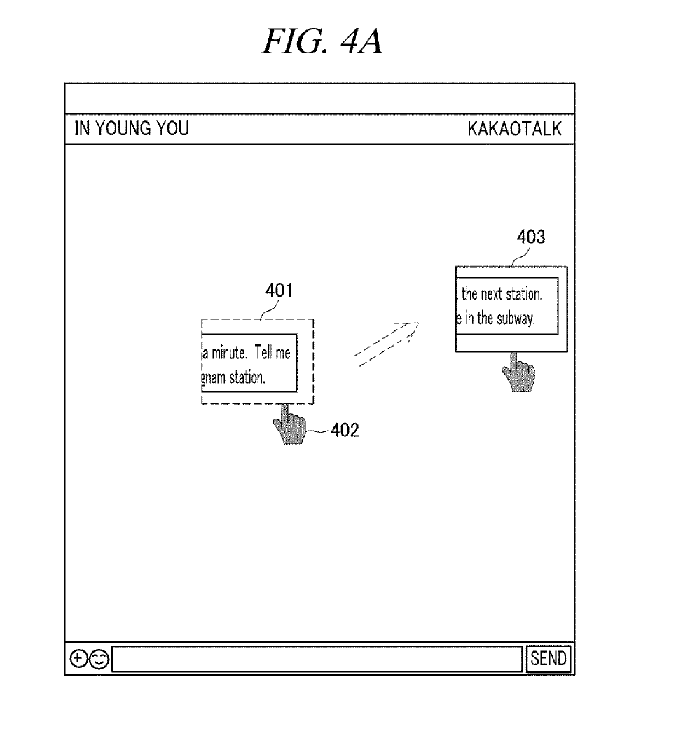

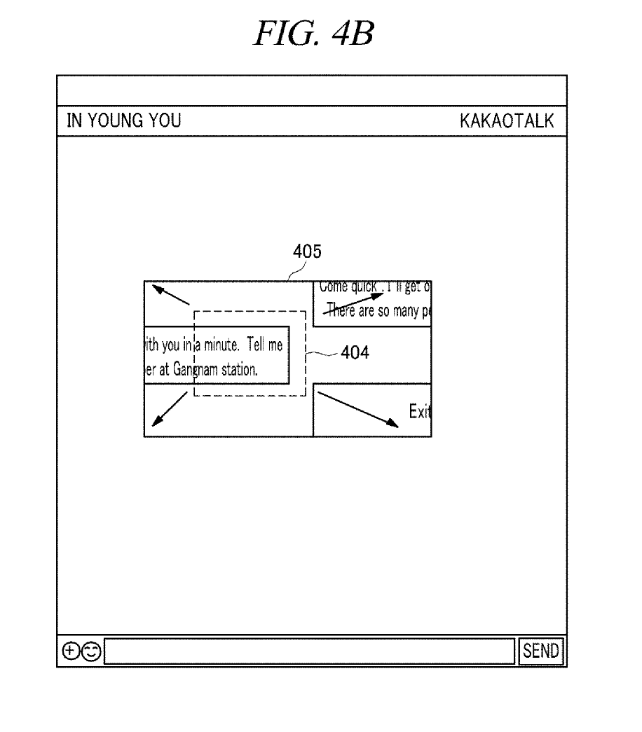

FIG. 4A is a diagram showing an example in which a non-security region is shifted in position. As exemplified in FIG. 4A, if a request for shifting the non-security region is input through the user interface, the display 22 may shift the non-security region from a first position 401 to a second position 403. In order to do so, the display 22 may use position information of the first position 401 and the second position 403 specified by a user interface icon 402.

As illustrated in FIG. 4A, if a selection of the non-security region (for example, a touch for several seconds or a double click on the non-security region) is input through the user interface, the display 22 activates the non-security region at the first position 401 into a shiftable state. In order to do so, the display 22 may show a graphic effect showing that the non-security region is presently activated into a shiftable state, by marking a boundary of the first position 401, which is the non-security region, with a dotted line or making flickers of the entire first position 401. As illustrated in FIG. 4A, if the non-security region at the first position 401 is shifted to the second position 403 by the icon 403, the display 22 changes the first position 401 into the security region and the second position 403 into the non-security region. As illustrated in FIG. 4A, in the second position 403 changed into the non-security region, a text is presented, and in the first position 401 changed into the security region, a text is hidden. For example, the shift request may include a drag of the user's fingertip from the first position 401 to the second position 403 on the display, but may not be limited thereto.

If the request for changing a size of the non-security region is input through the user interface, the display 22 may change the non-security region from the first size to the second size. In this case, the security function controller 24 may generate a control signal for changing a size of the non-security region from the first size to the second position in response to the size change request input through the user interface and transfer the generated control signal to the display 22.

FIG. 4B is a diagram showing an example in which a non-security region is changed in size. The user may change a size of the non-security region displayed on the chatting region through the touch interface serving as a user interface. As exemplified in FIG. 4B, the user may change a size of the non-security region from a first size 404 to a second size 405 through the touch interface. If an instruction to change a size of the non-security region is input through the user interface, the signal input receiver 23 may detect position information or size information corresponding to the changed size of the displayed non-security region on the basis of the input size change instruction.

The display 22 may change a size of the non-security region displayed as a region corresponding to the detected position information or size information. Herein, the detected position information may be 2D coordinates including x-axis and y-axis positions, or 3D coordinates including x-axis, y-axis, and z-axis positions. Further, the size information may be size information of a predetermined square representing the non-security region. Generally, a change in size may include enlargement and reduction of the non-security region.

As exemplified in FIG. 4B, the display 22 may increase a size of the non-security region from the first size 404 to the second size 405 in response to the size change request input through the user interface. In this case, if a selection of the non-security region (for example, a touch for several seconds or a double click on the non-security region) is input through the user interface, the display 22 may display the non-security region of the first size 404 as being in a changeable state. In order to do so, the display may show a graphic effect showing that the non-security region is in a changeable state, by marking a boundary of the non-security region of the first size 404 with a dotted line or making flickers of the entire non-security region.

As illustrated in FIG. 4B, if the non-security region is enlarged from the first size 404 to the second size 405 through the user interface, the display 22 activates the non-security region to be of the second size 405. A text corresponding to the activated second size 405 is presented on the non-security region. A request for changing the non-security region may be input by moving the user's two fingers (for example, the user's index finger and middle finger) in different directions (for example, opposite directions), but may not be limited thereto. The display 22 presents a text on the non-security region of the second size 405.

The display 22 may reduce a size of the non-security region from a first size to a second size in response to the size change request input through the user interface. To be specific, if the non-security region is reduced from the first size to the second size through the user interface, the display 22 activates the non-security region to be of the reduced second size. A text corresponding to the activated second size is presented on the non-security region. A request for changing the non-security region may be input by moving the user's two fingers (for example, the user's index finger and middle finger) toward the center of the non-security region, but may not be limited thereto. The display 22 presents a text on the non-security region of the second size.

According to another exemplary embodiment of the present disclosure, the display 22 displays surrounding regions respectively corresponding to multiple chatting texts as security regions, and if any one of the multiple surrounding regions is selected through the user interface, the display 22 may change the selected surrounding region into a non-security region. In this case, the display 22 may perform an operation corresponding to a control signal of the security function controller 24.

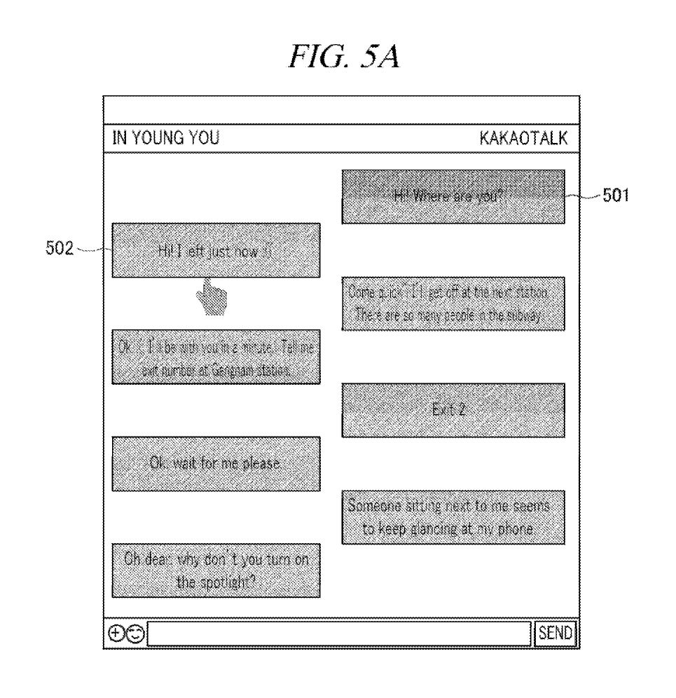

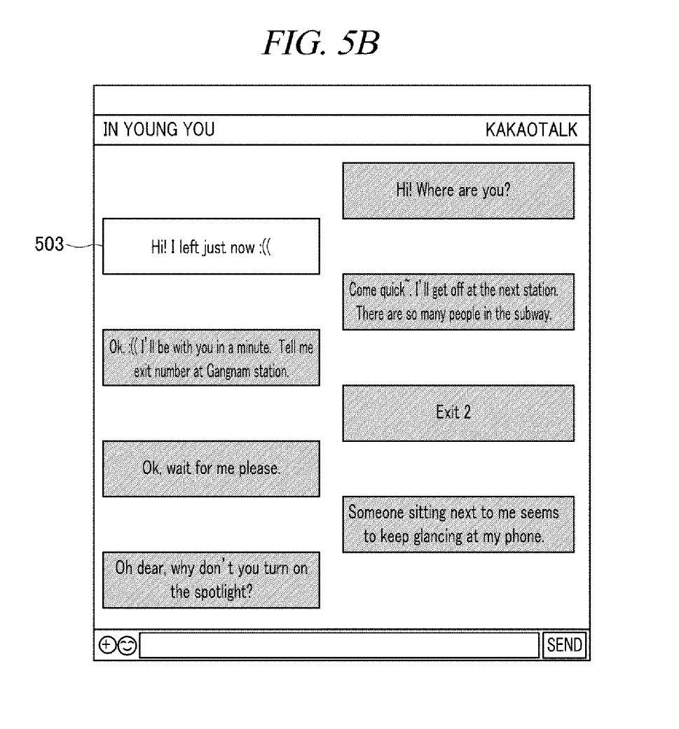

FIG. 5A and FIG. 5B are diagrams showing a process for activating a security function according to another exemplary embodiment of the present disclosure. If the display 22 receives a security request signal from the user interface, the display 22 may activate a security function for a surrounding region of each chatting region displayed on the display. As exemplified in FIG. 5A, the display 22 may display multiple surrounding regions including a surrounding region 501 of a chatting text “Hi! Where are you?” and a surrounding region 502 of a chatting text “Hi! I left just now :((?” as security regions. Herein, each of the multiple surrounding regions includes chatting data as illustrated in FIG. 5A.

As exemplified in FIG. 5B, if any one surrounding region 503 of the multiple surrounding regions is selected through the user interface, the display 22 may change the selected surrounding region 503 into a non-security region. Herein, the selection of any one surrounding region 503 may be carried out by the user's touch or click.

As exemplified in FIG. 5A and FIG. 5B, each of the multiple surrounding regions may be activated as a security region by overlaying an opaque image on each of the multiple surrounding regions, dimply displaying each of the multiple surrounding regions, changing transparency, or changing a color. Further, as exemplified in FIG. 5A and FIG. 5B, any one surrounding region 503 of the multiple surrounding regions may be activated as a non-security region by removing the opaque image overlaid on the surrounding region 503, or may be changed into a non-security region by brightly displaying the surrounding region 503, changing transparency, or changing a color.

The display 22 may present a security icon on the display. If the security icon presented on the display is selected through the user interface, the signal input receiver 23 may receive the selection of the security icon as a security request signal. Further, if the security icon is reselected through the user interface, the security function controller 24 may deactivate a security function.

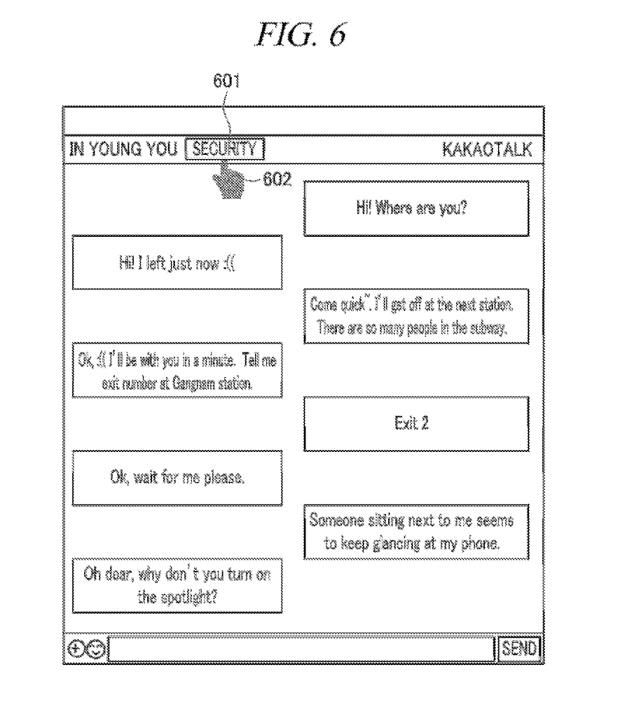

FIG. 6 is a diagram showing an example of a security icon. Referring to FIG. 6, the display 22 presents a security icon 601 on a chatting region or a peripheral region of the chatting region. Referring to FIG. 6, if the security icon 601 presented on the display is selected through an icon 602 of the user interface, the signal input receiver 23 may receive the selection of the security icon 601 as a security request signal. The security function controller 24 may display a non-security region differently from a security region in the chatting region in response to the input security request signal.

Referring to FIG. 6, if the security icon 601 is reselected through the icon 602 of the user interface, the security function controller 24 may deactivate a security function. The display 22 may display the entire chatting region as a non-security region under the control of the security function controller 24.

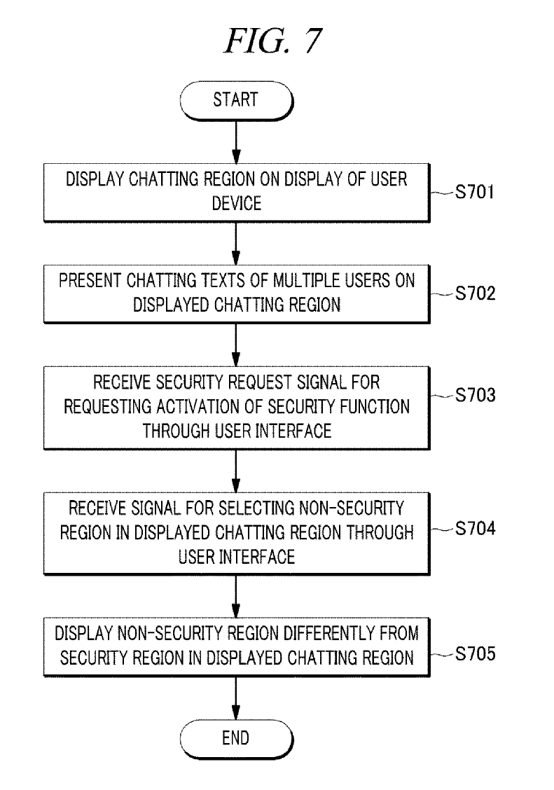

FIG. 7 is a flowchart of a method for activating a security function according to an exemplary embodiment of the present disclosure. A method for displaying an image according to an exemplary embodiment illustrated in FIG. 7 includes the processes time-sequentially performed in the device 20 according to the exemplary embodiment illustrated in FIG. 2. Therefore, even if omitted below, any of the descriptions given above in relation to the device 20 according to the exemplary embodiment illustrated in FIG. 2 may be applied to the method for activating a security function according to the exemplary embodiment illustrated in FIG. 7.

In block S701, the display 22 displays a chatting region on a display of a user device. In block S702, the display 22 presents chatting texts of multiple users on the displayed chatting region. In block S703, the signal input receiver 23 receives a security request signal for requesting activation of a security function through a user interface. In block S704, the signal input receiver 23 receives a signal for a non-security region in the displayed chatting region through the user interface. In block S705, the security function controller 24 displays the non-security region differently from a security region in the displayed chatting region.

Although not illustrated in FIG. 7, if a request for shifting the non-security region is input through the user interface, the method for activating a security function may further include a process for shifting the non-security region from a first position to a second position. Further, although not illustrated in FIG. 7, if a request for changing a size of the non-security region is input through the user interface, the method for activating a security function may further include a process for changing a size of the non-security region from a first size to a second size.

Although not illustrated in FIG. 7, if a security icon presented on the display is selected through the user interface, the signal input receiver 23 may receive the selection of a security icon as a security request signal for requesting activation of a security function in block S703. In this case, if the security icon is reselected through the user interface, the method for activating a security function may further include a process for deactivating the security function.

Although not illustrated in FIG. 7, in block S705, the security region may include multiple surrounding regions of multiple chatting texts, respectively. In this case, if any one of the multiple surrounding regions is selected through the user interface, the method for activating a security function may further include a process for changing the selected surrounding region into a non-security region.

The method for activating a security function described above with reference to FIG. 7 can be embodied in a storage medium including instruction codes executable by a computer such as a program module executed by the computer. Besides, the data structure in accordance with the embodiment of the present disclosure can be stored in the storage medium executable by the computer. A computer readable medium can be any usable medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes a certain information transmission medium.

An exemplary embodiment of the present disclosure may provide a method for providing a predetermined application in association with the device 20 that performs the method for activating a security function described with reference to FIG. 7. In this case, the device 20 performs the method for activating a security function. Further, the application may be provided to the device 20 by the chatting server 10, or may be provided to the device 20 by another server provided separately from the chatting server 10, or may be provided to the device 20 by another server operated by an entity different from that of the chatting server 10.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A method that activates a security function, the method comprising:
displaying a chatting region on a display of a user device;
presenting chatting texts of multiple users on the displayed chatting region;
receiving a security request signal for requesting activation of the security function through a user interface;
receiving a signal for selecting a non-security region in the displayed chatting region through the user interface; and
displaying the non-security region differently from a security region in the displayed chatting region.

2. The method of claim 1, further comprising:
if a request for the non-security region is input through the user interface, graphically modifying at least one of the security region and the non-security region on the basis of the input request.

3. The method of claim 2, wherein the modifying includes:
if the request is to shift the non-security region, graphically modifying at least one of the security region and the non-security region to shift the non-security region from a first position to a second position;
if the request is to change a size of the non-security region, graphically modifying at least one of the security region and the non-security region to change the size of the non-security region from a first size to a second size; or
if the request is to randomly shift the non-security region, graphically modifying at least one of the security region and the non-security region to randomly shift the non-security region between at least two positions.

4. The method of claim 1, wherein the displaying the non-security region differently from a security region is performed based on any one of the following methods comprising:
a first method that displays the non-security region differently from the security region by presenting an opaque image of the same size and shape as the security region on the display, and
a second method that displays the non-security region differently from the security region by dimly displaying the security region which is the rest of the displayed chatting region except the non-security region.

5. The method of claim 1, wherein the security request signal is generated when a security icon presented on the display is selected through the user interface, and
wherein the method further comprises: if the security icon is reselected through the user interface, deactivating the security function.

6. The method of claim 1, wherein the security region includes multiple surrounding regions of multiple chatting texts, respectively, and
wherein the method further comprises: if any one of the multiple surrounding regions is selected through the user interface, changing the selected surrounding region into the non-security region

7. A method for providing an application operating in association with a device that performs a method for activating a security function,
wherein the device performs any one of the methods recited in claim 1 to claim 6.

8. A device comprising:
a display configured to display a chatting region and present chatting texts of multiple users on the displayed chatting region;
a signal input receiver configured to receive a security request signal for requesting activation of a security function through a user interface and receive a signal for selecting a non-security region in the displayed chatting region through the user interface; and
a security function controller configured to display the non-security region differently from a security region in the displayed chatting region.
